(19) United States
(12) Patent Application Publication
(10) Pub. No.: US 2025/0142176 A1
(43) Pub. Date: May 1, 2025

(54) METHOD FOR TEXT PROCESSING, COMPUTER DEVICE, AND STORAGE MEDIUM

(71) Applicant: Beijing Zitiao Network Technology Co., Ltd., Beijing (CN)

(72) Inventors: Xu LUO, Beijing (CN); Zhenyuan QIU, Beijing (CN); Yifan ZHU, Beijing (CN)

(21) Appl. No.: 18/926,175

(22) Filed: Oct. 24, 2024

(30) Foreign Application Priority Data
Oct. 25, 2023 (CN) 202311397794.5

(51) Int. Cl. H04N 21/488; G06F 40/279; G10L 15/26

(52) U.S. Cl. CPC H04N 21/4884; G06F 40/279; G10L 15/26

(57) ABSTRACT

A method for text processing, a computer device, and a storage medium are provided. The method includes: acquiring a first text and a second text which are to be compared, the first text being a text obtained after text conversion processing is carried out on a dubbed audio corresponding to the second text by an artificial intelligence model; segmenting the first text to obtain a plurality of first text segments; segmenting the second text to obtain a plurality of initial second text segments; for each first text segment in the first text, sequentially determining a target second text segment that is subjected to an enhancement processing and matched with the first text segment; and based on a plurality of target second text segments respectively matched with the plurality of first text segments in the first text, determining a text matching result of the first text and the second text.

### CROSS-REFERENCE TO RELATED APPLICATION

This application claims the priority to and benefits of the Chinese Patent Application, No. 202311397794.5, which was filed on Oct. 25, 2023 and is hereby incorporated by reference in its entirety.

### TECHNICAL FIELD

The present disclosure relates to the field of computer technology, and particularly, to a method for text processing, a computer device, and a storage medium.

### BACKGROUND

With the development of the Internet technology, more and more users read text content such as a fiction, a masterwork, etc. by a reading-type application or a web page. The user can listen to an audio text content, or can read a literal content by using the reading-type application.

When a user listens to an audio text content by using a reading-type application, in order to facilitate knowing a currently played text content by the user, a literal content obtained after text conversion is carried out on a dubbed audio of the audio text content is displayed, generally. However, when the literal content obtained after text conversion is carried out on the dubbed audio is displayed, generally, there is a problem that the played audio content cannot accurately correspond to the positioned literal content obtained after audio conversion.

### SUMMARY

At least one embodiment of the present disclosure provides a method for text processing, a computer device or a storage medium.

At least one embodiment of the present disclosure provides a method for text processing, which includes:
acquiring a first text and a second text which are to be compared, the first text being a text obtained after text conversion processing is carried out on a dubbed audio corresponding to the second text by an artificial intelligence model;
segmenting the first text to obtain a plurality of first text segments; segmenting the second text to obtain a plurality of initial second text segments, the content length of a first text segment being greater than the content length of an initial second text segment;
for each first text segment in the first text, sequentially determining a target second text segment that is subjected to an enhancement processing and matched with the first text segment, the enhancement processing referring to movement processing carried out on an endpoint position of an initial second text segment as a processing target in the second text; and
based on a plurality of target second text segments respectively matched with the plurality of first text segments in the first text, determining a text matching result of the first text and the second text, the text matching result being used for positioning to a corresponding first text segment, based on a second text segment corresponding to a current dubbed content, in the process of playing the dubbed audio and synchronously displaying the first text.

In an optional embodiment, the for each first text segment in the first text, sequentially determining a target second text segment that is subjected to an enhancement processing and matched with the first text segment includes:
according to a logical sequence of each first text segment in the first text, sequentially determining the target second text segment that is subjected to an enhancement processing and matched with the first text segment according to steps as follows:
determining an initial second text segment to be matched with the first text segment;
carrying out the enhancement processing on the initial second text segment to obtain an enhanced second text segment corresponding to the initial second text segment; and
in response to the similarity between the enhanced second text segment and the first text segment being greater than a first set threshold, using the enhanced second text segment as the target second text segment matched with the first text segment, and in response to the similarity between the enhanced second text segment and the first text segment being smaller than or equal to the first set threshold, repeatedly executing the step of determining the initial second text segment to be matched with the first text segment, until the target second text segment that is subjected to the enhancement processing and matched with the first text segment is determined.

In an optional embodiment, the carrying out the enhancement processing on the initial second text segment to obtain an enhanced second text segment corresponding to the initial second text segment includes:
carrying out a plurality of first movement processing on a first endpoint position of the initial second text segment in the second text to obtain a first enhanced text segment, the first enhanced text segment being an enhanced text segment with a highest similarity with the first text segment, which is obtained after the plurality of first movement processing is carried out on the first endpoint position;
carrying out a plurality of second movement processing on a second endpoint position of the first enhanced text segment in the second text to obtain a second enhanced text segment, the second enhanced text segment being an enhanced text segment with a highest similarity with the first text segment, which is obtained after the plurality of second movement processing is carried out on the second enhanced text segment; and
in response to the similarity between the second enhanced text segment and the first text segment being greater than or equal to a second set threshold, using the second enhanced text segment as the enhanced second text segment.

In an optional embodiment, the first endpoint position is a right endpoint position of the initial second text segment, and compared to a left endpoint position, the right endpoint position is farther away from an initial position of the second text; and
the carrying out a plurality of first movement processing on a first endpoint position of the initial second text segment in the second text to obtain a first enhanced text segment includes:
according to a preset movement length added value, moving the right endpoint position of the initial second text segment to be matched rightwards by N times to obtain N first candidate text segments corresponding to the initial second text segment to be matched, the difference between a content length of an Nth first candidate text segment and a content length of an N-1th first candidate text segment being equal to the preset movement length added value, and N being a positive integer greater than or equal to 2;
determining a second candidate text segment with a highest similarity with the first text segment in the N first candidate text segments;
according to a target movement length, respectively moving a right endpoint position of the second candidate text segment leftwards and rightwards to obtain a third candidate text segment and a fourth candidate text segment; determining a target candidate text segment with a highest similarity with the first text segment among the second candidate text segment, the third candidate text segment, and the fourth candidate text segment;
according to a movement length reduction coefficient and the target movement length, determining an updated target movement length when a right endpoint position of the target candidate text segment is respectively moved leftwards and rightwards; and
in response to the target movement length being a positive integer, according to the target movement length, respectively moving the right endpoint position of the target candidate text segment leftwards and rightwards to obtain a new target candidate text segment, repeatedly executing a step of according to the movement length reduction coefficient and the target movement length, determining the target movement length used when a right endpoint position of the target candidate text segment is respectively moved leftwards and rightwards, until the target movement length determined is a non-positive integer, and using the target candidate text segment obtained after last respective leftward and rightward movements as the first enhanced text segment.

In an optional embodiment, after the determining the target second text segment that is subjected to an enhancement processing and matched with the first text segment, the method further includes:
determining a third text segment failed in matching in the first text;
for each third text segment, executing a step of determining an initial second text segment to be matched;
in response to a similarity between the obtained enhanced second text segment and the third text segment being greater than a third set threshold, using the enhanced second text segment as a target second text segment matched with the third text segment; and in response to the similarity between the enhanced second text segment and the third text segment being smaller than or equal to the third set threshold, repeatedly executing a step of determining the initial second text segment to be matched, until the target second text segment that is subjected to the enhancement processing and matched with the third text segment is determined, the third set threshold being smaller than the second set threshold.

In an optional embodiment, the determining an initial second text segment to be matched includes:
determining a matched text in the second text; and
using a text segment positioned behind an end of the matched text as the initial second text segment to be matched.

In an optional embodiment, whether the similarity between the enhanced second text segment and the first text segment is greater than the first set threshold is determined by:
determining a first pinyin unit corresponding to each word in the enhanced second text segment and a second pinyin unit corresponding to each word in the first text segment; and
according to a similarity between each first pinyin unit and each second pinyin unit, determining whether the similarity between the enhanced second text segment and the first text segment is greater than the first set threshold.

In an optional embodiment, after the determining a text matching result of the first text and the second text, the method further includes:
in response to a playing triggering operation for the second text, playing the dubbed audio corresponding to the second text;
according to the second text segment corresponding to the current dubbed content and the text matching result, determining a first text segment corresponding to the second text segment; and
in the process of playing the dubbed audio, synchronously displaying positioning to the determined first text segment of the first text.

At least one embodiment of the present disclosure provides an apparatus for text processing, which includes:
an acquisition module configured to acquire a first text and a second text which are to be compared, the first text being a text obtained after text conversion processing is carried out on a dubbed audio corresponding to the second text by an artificial intelligence model;
a segmentation module configured to segment the first text to obtain a plurality of first text segments, and segment the second text to obtain a plurality of initial second text segments, the content length of the first text segment being greater than the content length of the initial second text segment;
a first determination module configured to, for each first text segment in the first text, sequentially determine a target second text segment that is subjected to an enhancement processing and matched with the first text segment, the enhancement processing referring to movement processing carried out on an endpoint position of an initial second text segment as a processing target in the second text; and
a second determination module configured to, based on a plurality of target second text segments respectively matched with the plurality of first text segments in the first text, determine a text matching result of the first text and the second text, the text matching result being used for positioning to the corresponding first text segment, based on the second text segment corresponding to a current dubbed content, in the process of playing the dubbed audio and synchronously displaying the first text.

At least one embodiment of the present disclosure provides a computer device, which includes at least one processor, at least one storage, and a bus, where the at least one storage stores machine-readable instructions executable by the at least one processor; the at least one processor communicates with the at least one storage through the bus upon running of the computer device, and the machine-readable instructions, upon being executed by the at least one processor, execute the method for text processing described above.

At least one embodiment of the present disclosure further provides a non-transient computer-readable storage medium which stores computer programs, the computer programs, upon being run by at least one processor, executing the method for text processing described above.

In order to make the aforementioned objects, features and advantages of the present disclosure more comprehensible, embodiments accompanied with the drawings are described in detail below.

### BRIEF DESCRIPTION OF DRAWINGS

To more clearly illustrate the embodiments of the present disclosure, the drawings required to be used for the embodiments are briefly described in the following. The drawings herein are incorporated into and form a part of the specification, illustrate embodiments consistent with the present disclosure, and are used in conjunction with the specification to explain the principles of the present disclosure. It should be understood that are only some embodiments of the present disclosure, and therefore should not be regarded as limiting the scope. For those skilled in the art, other drawings can be obtained based on these drawings without any inventive work.

FIG. 1 is a flowchart of a method for text processing provided by an embodiment of the present disclosure;

FIG. 2 is a schematic diagram of an effect of synchronously displaying positioning to a first text segment in the process of playing a dubbed audio, as provided by an embodiment of the present disclosure;

FIG. 3 is a structural schematic diagram of an apparatus for text processing provided by an embodiment of the present disclosure; and

FIG. 4 is a schematic diagram of a computer device provided by an embodiment of the present disclosure.

### DETAILED DESCRIPTION

To make the objects, technical solutions and advantages of the present disclosure clearer, the technical solutions of the embodiments of the present disclosure will be described clearly and fully understandable in conjunction with the drawings related to the embodiments of the present disclosure. Apparently, the described embodiments are just a part but not all of the embodiments of the present disclosure. The components in the embodiments of the present disclosure generally described and illustrated in the drawings herein may be arranged and designed in various different configurations. Therefore, the following detailed description of the embodiments of the present disclosure provided in the accompanying drawings is not intended to limit the scope of the claimed disclosure, but merely represents selected embodiments of the present disclosure. Based on the described embodiments herein, those skilled in the art can obtain other embodiment(s), without any inventive work, which should be within the scope of the present disclosure.

With the development of the Internet technology, more and more users read text content such as a fiction, a masterwork, etc. by a reading-type application or a web page. The user can listen to an audio text content, or can read a literal content by using the reading-type application.

When a user listens to an audio text content by using a reading-type application, in order to facilitate knowing a currently played text content by the user, a literal content obtained after text conversion is carried out on a dubbed audio of the audio text content is displayed, generally. However, when the literal content obtained after text conversion is carried out on the dubbed audio is displayed, generally, there is a problem that the played audio content cannot accurately correspond to the positioned literal content obtained after audio conversion.

On this basis, the present disclosure provides a method for text processing, including: acquiring a first text and a second text which are to be compared, the first text being a text obtained after text conversion processing is carried out on a dubbed audio corresponding to the second text by an artificial intelligence model; segmenting the first text to obtain a plurality of first text segments, and segmenting the second text to obtain a plurality of initial second text segments, the content length of the first text segment being greater than the content length of the initial second text segment; for each first text segment in the first text, sequentially determining a target second text segment that is subjected to an enhancement processing and matched with the first text segment, the enhancement processing referring to movement processing carried out on an endpoint position of the initial second text segment as a processing target in the second text; and based on a plurality of target second text segments respectively matched with the plurality of first text segments in the first text, determining a text matching result of the first text and the second text, the text matching result being used for positioning to the corresponding first text segment, based on the second text segment corresponding to a current dubbed content, in the process of playing the dubbed audio and synchronously displaying the first text.

According to the method for text processing provided by the present disclosure, after the first text and the second text which are to be compared are acquired, for each first text segment in the first text, sequentially determining a target second text segment that is subjected to an enhancement processing and matched with the first text segment, the target second text segment is obtained after movement processing is carried out on the endpoint position of the initial second text segment in the second text, i.e., is obtained after the initial second text segment is adjusted, so that the first text segment can be matched with the corresponding target second text segment better, and then the corresponding first text segment in the first text can be positioned based on the second text segment corresponding to the current dubbed content in the process of playing the dubbed audio and synchronously displaying the first text, thereby implementing accurate positioning to a specific content of an audio conversion text according to the playing progress.

Both the existing defects of the solution above and the proposed solution are results produced after an inventor carries out practice and makes a study carefully, and thus, the finding process of the problems above and the solution proposed hereinafter for the problems above by the present disclosure both should be contributions made to the present disclosure by the inventor in this disclosing process.

It should be noted that like reference numbers and letters refer to like items in the following drawings, and thus, once an item is defined in one drawing, it need not be further defined or explained in subsequent drawings.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

In order to facilitate understanding this embodiment, a method for text processing disclosed by the embodiment of the present disclosure is illustrated in detail first, and an executive body for the method for text processing provided by the embodiment of the present disclosure generally is a computer device with a certain computing power.

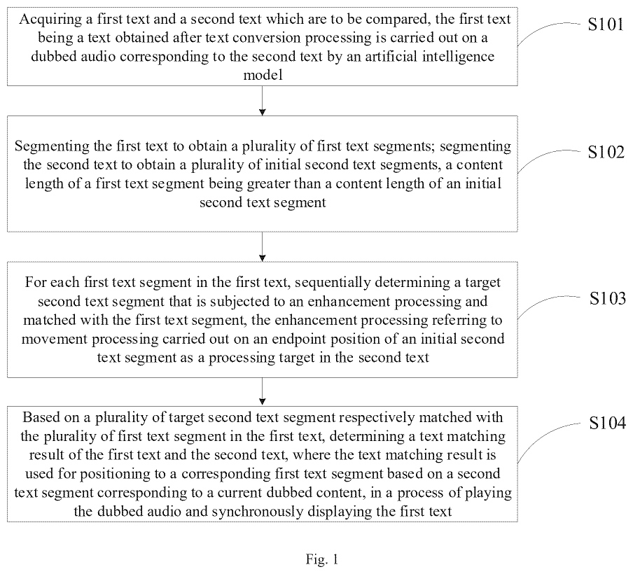

Referring to FIG. 1, it is a flowchart of a method for text processing provided by an embodiment of the present disclosure. The method includes S101-S104.
S101: acquiring a first text and a second text which are to be compared, the first text being a text obtained after text conversion processing is carried out on a dubbed audio corresponding to the second text by an artificial intelligence model.
S102: segmenting the first text to obtain a plurality of first text segments; segmenting the second text to obtain a plurality of initial second text segments, a content length of a first text segment being greater than a content length of an initial second text segment.
S103: for each first text segment in the first text, sequentially determining a target second text segment that is subjected to an enhancement processing and matched with the first text segment, the enhancement processing referring to movement processing carried out on an endpoint position of an initial second text segment as a processing target in the second text.
S104: based on a plurality of target second text segment respectively matched with the plurality of first text segment in the first text, determining a text matching result of the first text and the second text, where the text matching result is used for positioning to a corresponding first text segment, based on a second text segment corresponding to a current dubbed content, in a process of playing the dubbed audio and synchronously displaying the first text.

In the embodiment of the present disclosure, the first text and the second text may include a long text of which the character length is greater than a preset character number. Exemplarily, the second text may include a text such as a novel manuscript with the character number of over 1 million, a video manuscript, etc. The first text and the second text also may include part of the long text.

The first text and the second text may be roughly corresponding text contents. The second text may be an original text; and the first text may be the text obtained after text conversion processing is carried out on the dubbed audio corresponding to the second text by the artificial intelligence model. The dubbed audio corresponding to the second text may include an audio obtained after live-action dubbing is carried out based on a text content of the second text. The first text may be obtained after text conversion processing is carried out on the dubbed audio corresponding to the second text by the artificial intelligence model. In one mode, the first text can be generated by an Artificial Intelligence Laboratory (AI-Lab) based on a Speech to Text (STT) natural language synthesis technology.

Exemplarily, the second text may be an original manuscript of a fiction, and the first text may be a manuscript generated by carrying out text conversion processing on a dubbed audio by adopting a STT technology after a dubber carries out dubbing according to the original manuscript of the fiction.

In the embodiment of the present disclosure, the first text and the second text may be respectively segmented to obtain text segments. For example, the first text may be segmented into a plurality of first text segments. The second text may be segmented into a plurality of initial second text segments.

The plurality of first text segments obtained by segmenting the first text may be arranged in the first text in a logical sequence, and the plurality of initial second text segments obtained by segmenting the second text may be arranged in the second text in a logical sequence.

The character numbers of the first text segment and the initial second text segment may fall within a preset character number range, and exemplarily, the character numbers of the first text segment and the initial second text segment may fall within a range of 5-25. The initial second text segments maybe text segments with the same character number. Therefore, the text granularities of the first text segment and the initial second text segment which are compared are made as small as possible, so that finer correspondence between the first text and the second text can be implemented.

In one mode, the content length of the first text segment may be greater than the content length of the initial second text segment, for example, the content length of any first text segment may be greater than the content length of any initial second text segment. The content length herein may include the character number, so that each first text segment respectively corresponds to at least one complete initial second text segment, and thus, a text segment in the second text, which is matched with the first text segment, can be accurately determined by carrying out relatively simple enhancement processing on the initial second text segment. Otherwise, the first text segment cannot correspond to at least one complete initial second text segment, and in this case, the text segment in the second text, which is matched with the first text segment, can be determined by carrying out relatively complex enhancement processing on the initial second text segment.

The enhancement processing may include movement processing carried out on the endpoint position of the initial second text segment in the second text. The process of carrying out the enhancement processing on the initial second text segment is illustrated in detail hereafter.

After the target second text segment respectively matched with each first text segment in the first text is obtained, the text matching result of the first text and the second text can be determined; and the text matching result may include a correspondence relationship between each first text segment and the matched target second text segment. The text matching result may be used for positioning to the corresponding first text segment, based on the second text segment corresponding to the current dubbed content and the text matching result, in the process of playing the dubbed audio and synchronously displaying the first text.

In one implementation mode, after the text matching result of the first text and the second text is determined, in response to a playing triggering operation for the second text, the dubbed audio corresponding to the second text can be played; according to the second text segment corresponding to the current dubbed content and the text matching result, a first text segment corresponding to the second text segment is determined; and in the process of playing the dubbed audio, positioning to the determined first text segment of the first text is synchronously displayed.

The implementation mode above may be applied to a scenario where a user reads the second text corresponding to a currently played content while listening to the dubbed audio corresponding to the first text. In a specific mode, when the dubbed audio corresponding to the first text is played, the user can trigger an operation of displaying the first text. In response to the displaying operation for the first text, the first text segment corresponding to the second text segment is determined; and then, in the process of playing the dubbed audio, positioning to the determined first text segment of the determined first text is synchronously displayed.

In the implementation mode above, in the process that the user listens to the dubbed audio of the first text, such as fiction dubbing, a text content corresponding to the current dubbed audio and obtained after text conversion processing is carried out by the artificial intelligence model can be displayed, so that the demand that the user reads while listening can be satisfied.

In one mode, in order to enable the user to rapidly track down the first text segment, in the process

of displaying the first text segment, the first text segment matched with the current dubbed content may be highlighted.

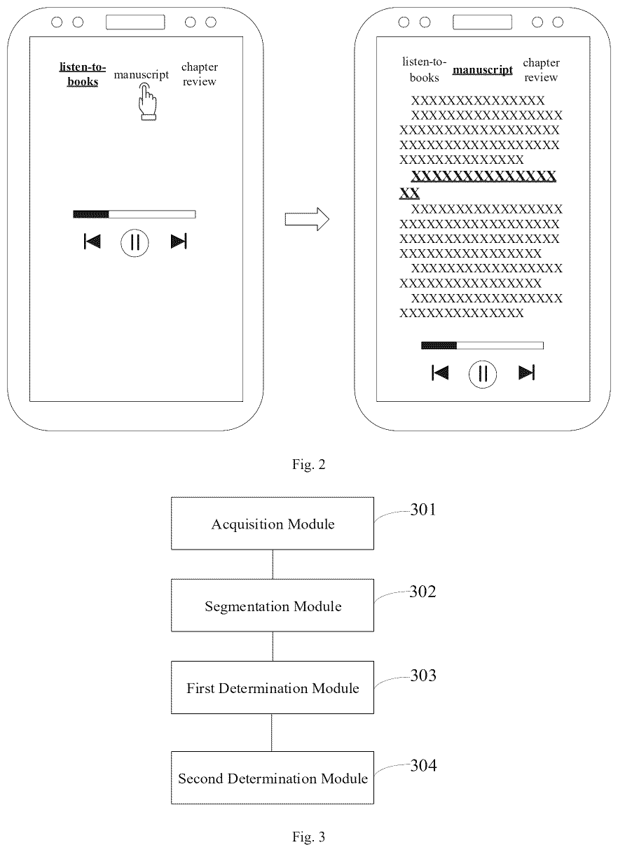

As shown in FIG. 2, the user triggers a playing operation for a target fiction, i.e., clicks on a “listen-to-books” button, and a progress bar corresponding to the target fiction and a play button may be displayed on a target page. After the user clicks on a “manuscript” button, a text segment corresponding to a text segment of an original text of the fiction and obtained after text conversion processing is carried out by an artificial intelligence model can be determined according to the text segment of the original text of the fiction corresponding to a current dubbed content and a text matching result, positioning to the text segment (i.e., a bold and underlined text segment in FIG. 2) obtained after text conversion processing is carried out by the artificial intelligence model is displayed, and meanwhile, the current dubbed content is played continuously. In the embodiment of the present disclosure, for each first text segment, in order to obtain the second text segment in the second text, which has a higher matching degree with the first text segment, a target second text segment that is subjected to an enhancement processing and matched with the first text segment may be determined. The target second text segment may be obtained after movement processing is carried out on the endpoint position of the initial second text segment in the second text, i.e., the target second text segment includes more character contents relative to the initial second text segment, and compared with the similarity between the initial second text segment and the first text segment, the similarity between the target second text segment and the first text segment is higher.

In one implementation mode, for each first text segment in the first text, sequentially determining the target second text segment that is subjected to an enhancement processing and matched with the first text segment may include: according to a logical sequence of each first text segment in the first text, sequentially determining the target second text segment that is subjected to an enhancement processing and matched with the first text segment according to the steps as follows: determining an initial second text segment to be matched with the first text segment; carrying out the enhancement processing on the initial second text segment to obtain an enhanced second text segment corresponding to the initial second text segment; and in response to the similarity between the enhanced second text segment and the first text segment being greater than a first set threshold, using the enhanced second text segment as the target second text segment matched with the first text segment, and in response to the similarity between the enhanced second text segment and the first text segment is smaller than or equal to the first set threshold, repeatedly executing the step of determining the initial second text segment to be matched with the first text segment, until the target second text segment that is subjected to the enhancement processing and matched with the first text segment is determined.

As previously mentioned, the enhancement processing may include movement processing carried out on the endpoint position of the initial second text segment in the second text. Herein, the enhancement processing may include movement processing carried out on a left endpoint position and/or a right endpoint position of the initial second text segment in the second text.

The initial second text segment to be matched with the first text segment may be a foremost second text segment in a plurality of initial second text segments to be matched, the plurality of initial second text segments to be matched may be arranged in the logical sequence.

In the step of sequentially determining the target second text segment that is subjected to an enhancement processing and matched with the first text segment, the initial second text segment may be adjusted in an enhancement processing mode, so that the adjusted target second text segment is matched with the first text segment better.

In the implementation mode above, a plurality of initial second text segments to be matched can be sequentially traversed according to the logical sequence. In one implementation mode, a matched text in the second text may be determined; and a text segment positioned behind the end of the matched text is used as the initial second text segment to be matched. Therefore, it can be ensured that the initial second text segments to be matched with the first text segment are sequentially traversed according to the logical sequence.

In response to the similarity between the enhanced second text segment obtained after enhancement processing is carried out on a current initial second text segment and the first text segment being smaller than or equal to the first set threshold, the step of determining the initial second text segment to be matched with the first text segment is repeatedly executed, i.e., a next initial second text segment in the plurality of initial second text segments to be matched is used as the initial second text segment to be matched with the first text segment.

In the implementation mode above, it may be determined whether the similarity between the enhanced second text segment and the first text segment is greater than the first set threshold according to the semantic similarity. In one mode, it may also be determined whether the similarity between the enhanced second text segment and the first text segment is greater than the first set threshold according to the pinyin similarity. For example, a first pinyin unit corresponding to each word in the enhanced second text segment and a second pinyin unit corresponding to each word in the first text segment may be determined; and according to the similarity between each first pinyin unit and each second pinyin unit, it is determined whether the similarity between the enhanced second text segment and the first text segment is greater than the first set threshold.

Characters with the same pronunciation may be regarded as the same character. By the implementation mode above, it can be rapidly determined whether the similarity between the enhanced second text segment and the first text segment is greater than the first set threshold.

In a further implementation mode, carrying out the enhancement processing on the initial second text segment to obtain the enhanced second text segment corresponding to the initial second text segment may include: carrying out a plurality of first movement processing on a first endpoint position of the initial second text segment in the second text to obtain a first enhanced text segment, where the first enhanced text segment is an enhanced text segment with the highest similarity with the first text segment, which is obtained after the plurality of first movement processing is carried out on the first endpoint position; carrying out a plurality of second movement processing on a second endpoint position of the first enhanced text segment in the second text to obtain a second enhanced text segment, where the second enhanced text segment is an enhanced text segment with the highest similarity with the first text segment, which is obtained after the plurality of second movement processing is carried out on the second enhanced text segment; and in response to the similarity between the second enhanced text segment and the first text segment being greater than or equal to a second set threshold, using the second enhanced text segment as the enhanced second text segment.

In the implementation mode above, the first endpoint position and the second endpoint position may be a right endpoint position and a left endpoint position, respectively. Compared to the left endpoint position, the right endpoint position is farther away from an initial position of the second text.

The movement direction of first movement processing may correspond to the endpoint position. When the first endpoint position is the right endpoint position, the first movement processing may include a rightward movement and a plurality of left-and-right movements; and when the second endpoint position is the left endpoint position, the first movement processing may include a leftward movement and a plurality of left-and-right movements.

In the embodiment of the present disclosure, it may be that firstly, the corresponding enhancement processing process is carried out on the right endpoint position of the initial second text segment in the second text, and then the corresponding enhancement processing process is carried out on the left endpoint position of the initial second text segment in the second text; or it may be that firstly, the corresponding enhancement processing process is carried out on the left endpoint position of the initial second text segment in the second text, and then the corresponding enhancement processing process is carried out on the right endpoint position of the initial second text segment in the second text.

By carrying out a plurality of first movement processing on the first endpoint position and carrying out a plurality of second movement processing on the second endpoint position, the initial second text segment can be respectively adjusted from the left and right endpoint positions of the initial second text segment, so that the matching degree between the adjusted target second text segment and the first text segment can be increased.

The process of carrying out the plurality of first movement processing on the first endpoint position is similar with the process of carrying out the plurality of second movement processing on the second endpoint position. The process of carrying out the plurality of first movement processing on the right endpoint position of the initial second text segment in the second text to obtain the first enhanced text segment is illustrated in detail below by taking a case that the first endpoint position is the right endpoint position in the initial second text segment as an example.

In one implementation mode, carrying out the plurality of first movement processing on the first endpoint position of the initial second text segment in the second text to obtain the first enhanced text segment may include:
according to a preset movement length added value, moving the right endpoint position in the initial second text segment to be matched rightwards by N times to obtain N first candidate text segments corresponding to the initial second text segment to be matched, where the difference between the content length of an N^{th} first candidate text segment and the content length of an N-1^{th} first candidate text segment is equal to the preset movement length added value, and N is a positive integer greater than or equal to 2; and determining a second candidate text segment with the highest similarity with the first text segment in the N first candidate text segments, and using the second candidate text segment as the first enhanced text segment.

According to the preset movement length added value, the right endpoint position in the initial second text segment to be matched is moved rightwards by N times, and one first candidate text segment corresponding to the initial second text segment can be obtained each time. The difference between the content length of the first candidate text segment obtained each time and the content length of the first candidate text segment obtained last time is equal to the preset movement length added value. According to the similarity between the first candidate text segment obtained each time and the first text segment, the second candidate text segment with the highest similarity with the first text segment can be selected from N first candidate text segments.

Then, according to a target movement length, a right endpoint position of the second candidate text segment is respectively moved leftwards and rightwards to obtain a third candidate text segment and a fourth candidate text segment; a target candidate text segment with the highest similarity with the first text segment in the second candidate text segment, the third candidate text segment, and the fourth candidate text segment is determined; and according to a movement length reduction coefficient and the target movement length, an updated target movement length when the right endpoint position of the target candidate text segment is respectively moved leftwards and rightwards is determined.

In response to the target movement length being a positive integer, according to the target movement length, the right endpoint position of the first enhanced text segment is respectively moved leftwards and rightwards to obtain a new target candidate text segments; the step of, according to the movement length reduction coefficient and the target movement length, determining the target movement length used when a right endpoint position of the target candidate text segment is respectively moved leftwards and rightwards is repeatedly executed, until the target movement length determined is a non-positive integer; and the target candidate text segment obtained after last respective leftward and rightward movements is used as the first enhanced text segment.

Each time when a plurality of leftward and rightward movement processing is carried out on the right endpoint position of the first enhanced text segment in the second text, the used target movement length may be determined according to the last target movement length and the movement length reduction coefficient. The movement length reduction coefficient may be a value smaller than 1, and thus, with the iteration of the process above, the target movement length may be always reduced.

A cut-off condition of the iteration process above is that the currently determined target movement length is a non-positive integer, i.e., rounding cannot be continued for the target movement length used last time, and at the moment, the process of carrying out leftward and rightward movement processing on the right endpoint position of the first enhanced text segment in the second text is completed.

The implementation mode above completes accurate matching on the right endpoint position of the first enhanced text segment in the second text.

In a specific implementation mode, a plurality of second movement processing may be carried out on a left endpoint position of the first enhanced text segment in the second text on the basis of the first enhanced text segment above to obtain the second enhanced text segment, and the specific process can refer to the process of carrying out a plurality of first movement processing on the right endpoint position of the initial second text segment in the second text to obtain the first enhanced text segment and will not be illustrated in detail herein.

In order to enable each text segment in the first text to be matched successfully, in one implementation mode, the first text may be matched again, i.e., after the target second text segment that is subjected to the enhancement processing and matched with each first text segment is determined, a third text segment failed in matching in the first text may also be determined; then for each third text segment, the step of determining the initial second text segment to be matched is executed; in response to the similarity between the obtained enhanced second text segment and the third text segment being greater than a third set threshold, the enhanced second text segment is used as the target second text segment matched with the third text segment; and in response to the similarity between the enhanced second text segment and the third text segment being smaller than or equal to the third set threshold, the step of determining the initial second text segment to be matched is repeatedly executed, until the target second text segment matched with the third text segment and obtained after enhancement processing is determined; and the third set threshold is smaller than the second set threshold.

In the implementation mode above, after the third text segment failed in matching in the first text is determined, an initial second text segment to be matched may be determined for each third text segment, and then enhancement processing is carried out on the initial second text segment to obtain the enhanced second text segment corresponding to the initial second text segment. The specific implementation mode of this process may refer to the above, and will not be repeated herein.

In this implementation mode, the used third set threshold is smaller than the second set threshold, and thus, the target second text segment that is subjected to the enhancement processing and matched with the third text segment can be determined more accurately.

In order to facilitate understanding the method for text processing provided by the embodiment of the present disclosure, the first text, the second text, the first text segment, the second text segment, and the like which are mentioned above can be defined first. Then, the method for text processing can be illustrated in detail according to the defined first text, second text, first text segment, and second text segment.

In one implementation mode, the first text may be defined as A, and each character in the first text A may be defined as An in a character sequence in the first text A, and thus, the first text A may be represented by An corresponding to each character. Exemplarily, A=“I like to cat French fries”, and A can be represented as [A0, A1, A2, A3, A4, A5]. A[x, y] may represent a text segment consisting of characters Ax to Ay. For example, A[0, 2] represents a text segment consisting of [A0, A1, A2], and in the above-mentioned example, A[0, 2]=“I like to”.

The second text may also be defined as B[0, m]. m may be determined according to the total character number of the second text. Exemplarily, for an original text of a novel, generally, m>106.

A series of time nodes exist in the first text A, and a corresponding text content in the first text A may be started at each time node. The first text A may be arranged according to the time nodes: [At0, At1 . . . ], where At0 may represent a text content started at a time node t0, At1 may represent a text content started at a time node t1, etc. A[t0, t1], A[t1, t2], . . . , A[tn, tn+1] can be obtained by segmenting the first text A, and by matching A[tn, tn+1] into a second text segment B[z, w] in a second text B, a text content in the second text segment B[z, w] can be displayed when a dubbed audio in a time period tn to tn+1 is played. z and w herein may be unknown.

For any one first text segment A[x, y], the content length for segmenting the second text B can be determined first.

Enabling pace0=p=(y−x)/2 and assuming that the second text B is started from s, the initial second text segment obtained after the second text B is segmented may include B[s, s+p], B[s+p, s+2p], B[s+2p,s+3p] . . . , and it can be seen that the difference between the content lengths of any two adjacent initial second text segments is half the content length of the first text segment A. Then, traversal is sequentially carried out from the beginning of the first initial second text segment B[s, s+p] so as to determine the target second text segment matched with the first text segment A[x, y].

For any one initial second text segment B[z1, z2] to be matched, firstly, a plurality of rightward movement processing may be carried out on a right endpoint position of the initial second text segment B[z1, z2] according to pace0 to obtain a plurality of first candidate text segments: B[z1, z2+pace0], B[z1, z2+2pace0], B[z1, z2+3pace0] . . . . A second candidate text segment B[z1, z2+n*pace0] with the highest similarity with the first text segment A[x, y] is selected from the plurality of first candidate text segments.

Then, leftward and rightward movement processing is carried out on a right endpoint position of the second candidate text segment B[z1, z2+n*pace0] for the first time. The target movement length for carrying out leftward and rightward movement processing for the first time may be that pace1=0.2*pace0 (rounded downwards). B[z1, z2+n*pace0−pace1] may be obtained by leftward movement processing; and B[z1, z2+n*pace0+pace1] may be obtained by rightward movement processing. Then, the target candidate text segment with the highest similarity with the first text segment A[x, y] is selected from the second candidate text segments B[z1, z2+n*pace0], B[z1, z2+n*pace0−pace1], and B[z1, z2+n*pace0+pace1]. At the moment, the target movement length is updated as pace2=0.2*pace1 (rounded downwards), the leftward and rightward movement processing process above is repeatedly executed, and until pacen=0.2*pacen−1 is a non-positive integer, the leftward and rightward movement processing process is ended. So far, the second text segment of which the right endpoint position is subjected to enhancement processing is obtained, and is recorded as B[z1, zright].

Next, a plurality of leftward movement processing and a plurality leftward and rightward movement processing may be carried out on a left endpoint z1 of B[z1, zright]. The specific process is similar with the above-mentioned process, and will not be repeated herein. Finally, the target second text segment of which the left endpoint position is subjected to enhancement processing can be obtained, and is recorded as B[zleft, zright].

Then, it is judged whether the similarity between B[zleft, zright] and the first text segment A[x, y] is greater than the first set threshold, and for example, the similarity may be set as 0.45.

In response to the similarity between B[zleft, zright] and the first text segment A[x, y] being greater than the first set threshold, the text segment B[zleft, zright] is a target second text segment matched with the first text segment A[x, y]; and in response to the similarity between B[zleft, zright] and the first text segment A[x, y] being smaller than or equal to the first set threshold, traversing a next initial second text segment is continued.

In response to the number of the traversed initial second text segments exceeding the second set threshold and for example, is 5, it can be regarded that matching is failed.

In the specific implementation, character offset conversion can be carried out on the first text and the second text according to a preset word-character proportion so as to obtain the character lengths corresponding to the first text and the second text, and then the process above is executed.

In order to enable each text segment in the first text to be matched successfully, after the matching process is executed by once, the third text segment failed in matching in the first text may also be determined, and then the matching process above is executed according to a new first set threshold (smaller than a set threshold used in the last matching process) so as to determine the target second text segment matched with the third text segment. By a plurality of matching process, the corresponding target second text segment can be matched out for each text segment in the first text.

Assuming that the first set threshold may be set as 0.75 in the first matching process, A[10, 25] is successfully matched to B[10, 24], and A[35, 40] is matched to B[38, 43]; and the first set threshold may be set as 0.55 in the second matching process, A[28, 32] is matched to B[h, k], h is greater than or equal to 24, and k is smaller than or equal to 38, i.e., a matched text segment is searched in B[24, 38] so as to reduce the search range.

Those skilled in the art could understand in the method in the specific implement mode, the writing sequence of each step does not mean a strict execution sequence to constitute any limitation to the implementing process, and the specific implementing process of each step should be determined with functions and possible internal logic thereof.

Based on the same inventive concept, an embodiment of the present disclosure further provides an apparatus for text processing corresponding to the method for text processing. The principle of solving the problem by the apparatus in the embodiment of the present disclosure is similar with that of the method for text processing in the embodiment of the present disclosure, and thus, implementation of the apparatus can refer to implementation of the method and will not be repeated herein.

Referring to FIG. 3, it is a structural schematic diagram of an apparatus for text processing provided by an embodiment of the present disclosure. The apparatus includes:
an acquisition module 301, configured to acquire a first text and a second text which are to be compared, the first text being a text obtained after text conversion processing is carried out on a dubbed audio corresponding to the second text by an artificial intelligence model;
a segmentation module 302, configured to segment the first text to obtain a plurality of first text segments, and segment the second text to obtain a plurality of initial second text segments, the content length of the first text segment being greater than the content length of the initial second text segment;
a first determination module 303, configured to, for each first text segment in the first text, sequentially determine a target second text segment that is subjected to an enhancement processing and matched with the first text segment, the enhancement processing referring to movement processing carried out on an endpoint position of an initial second text segment as a processing target in the second text; and
a second determination module 304, configured to, based on a plurality of target second text segments respectively matched with the plurality of first text segments in the first text, determine a text matching result of the first text and the second text, the text matching result being used for positioning to the corresponding first text segment, based on the second text segment corresponding to a current dubbed content, in the process of playing the dubbed audio and synchronously displaying the first text.

In an optional implementation mode, the first determination module 303 is specifically configured to:
according to a logical sequence of each first text segment in the first text, sequentially determine the target second text segment that is subjected to an enhancement processing and matched with the first text segment according to the steps as follows:
determining an initial second text segment to be matched with the first text segment;
carrying out the enhancement processing on the initial second text segment to obtain an enhanced second text segment corresponding to the initial second text segment; and
in response to the similarity between the enhanced second text segment and the first text segment being greater than a first set threshold, using the enhanced second text segment as the target second text segment matched with the first text segment, and in response to the similarity between the enhanced second text segment and the first text segment being smaller than or equal to the first set threshold, repeatedly executing the step of determining the initial second text segment to be matched with the first text segment, until the target second text segment that is subjected to the enhancement processing and matched with the first text segment is determined.

In an optional implementation mode, the first determination module 303 is specifically configured to:
carry out a plurality of first movement processing on a first endpoint position of the initial second text segment in the second text to obtain a first enhanced text segment, the first enhanced text segment being an enhanced text segment with the highest similarity with the first text segment, which is obtained after the plurality of first movement processing is carried out on the first endpoint position;
carry out a plurality of second movement processing on a second endpoint position of the first enhanced text segment in the second text to obtain a second enhanced text segment, the second enhanced text segment being an enhanced text segment with a highest similarity with the first text segment, which is obtained after the plurality of second movement processing is carried out on the second enhanced text segment; and
in response to the similarity between the second enhanced text segment and the first text segment being greater than or equal to a second set threshold, using the second enhanced text segment as the enhanced second text segment.

In an optional implementation mode, the first endpoint position is a right endpoint position in the initial second text segment, and compared to a left endpoint position, the right endpoint position is farther away from an initial position of the second text; and
the first determination module 303 is specifically configured to:
according to a preset movement length added value, move the right endpoint position in the initial second text segment to be matched rightwards by N times to obtain N first candidate text segments corresponding to the initial second text segment to be matched, the difference between the content length of an N^{th} first candidate text segment and the content length of an N-1^{th} first candidate text segment being equal to the preset movement length added value, and N being a positive integer greater than or equal to 2;
determine a second candidate text segment with the highest similarity with the first text segment in the N first candidate text segments;
according to a target movement length, respectively move a right endpoint position of the second candidate text segment leftwards and rightwards to obtain a third candidate text segment and a fourth candidate text segment; determine a target candidate text segment with the highest similarity with the first text segment among the second candidate text segment, the third candidate text segment, and the fourth candidate text segment;
according to a movement length reduction coefficient and the target movement length, determine an updated target movement length when the right endpoint position of the target candidate text segment is respectively moved leftwards and rightwards; and
in response to the target movement length being a positive integer, according to the target movement length, respectively move the right endpoint position of the target candidate text segment leftwards and rightwards to obtain a new target candidate text segment, repeatedly execute the step of, according to the movement length reduction coefficient and the target movement length, determining the target movement length used when a right endpoint content of the target candidate text segment is respectively moved leftwards and rightwards, until the target movement length determined is a non-positive integer, and use the target candidate text segment obtained after last respective leftward and rightward movements as the first enhanced text segment.

In an optional implementation mode, the first determination module 303 is specifically configured to:
determine a third text segment failed in matching in the first text;
for each third text segment, execute the step of determining an initial second text segment to be matched;
in response to the similarity between the obtained enhanced second text segment and the third text segment is greater than a third set threshold, use the enhanced second text segment as the target second text segment matched with the third text segment; and in response to the similarity between the enhanced second text segment and the third text segment is smaller than or equal to the third set threshold, repeatedly execute the step of determining the initial second text segment to be matched, until the target second text segment that is subjected to the enhancement processing and matched with the third text segment is determined, the third set threshold being smaller than the second set threshold.

In an optional implementation mode, the first determination module 303 is specifically configured to:
determine a matched text in the second text; and
use a text segment positioned behind an end of the matched text as the initial second text segment

to be matched.

In an optional implementation mode, the first determination module is specifically configured to:
determine a first pinyin unit corresponding to each word in the enhanced second text segment and a second pinyin unit corresponding to each word in the first text segment; and
according to a similarity between each first pinyin unit and each second pinyin unit, determine whether the similarity between the enhanced second text segment and the first text segment is greater than the first set threshold.

In an optional implementation mode, the apparatus further includes:
a playing module, configured to, in response to a playing triggering operation for the second text, play the dubbed audio corresponding to the second text;
a third determination module, configured to, according to the second text segment corresponding to the current dubbed content and the text matching result, determine a first text segment corresponding to the second text segment; and
a display module, configured to, in the process of playing the dubbed audio, synchronously displaying positioning to the determined first text segment of the first text.

The description about the processing flow of each module in the apparatus and the flow of interaction among all the modules may refer to related illustration in the method embodiment above, and will not be illustrated in detail herein.

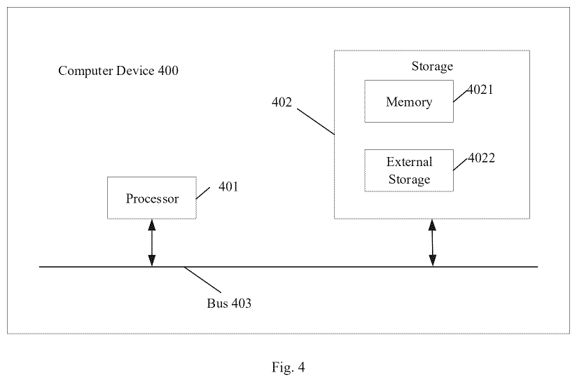

Based on the same technical conception, an embodiment of the present disclosure further provides a computer device. Referring to FIG. 4, it is a schematic diagram of a computer device 400 provided by an embodiment of the present disclosure. The computer device 400 includes a processor 401, a storage 402, and a bus 403, where the storage 402 is configured to store an executive instruction and includes a memory 4021 and an external storage 4022; the memory 4021 herein is also referred to as an internal storage, and is used for temporarily storing operational data in the processor 401 and data exchanged with the external storage 4022 such as a hard disk, etc.; the processor 401 carries out data exchange with the external storage 4022 through the memory 4021; and when the computer device 400 runs, the processor 401 is communicated with the storage 402 through the bus 403, so that the processor 401 executes the instructions as follows:
acquiring a first text and a second text which are to be compared, the first text being a text obtained after text conversion processing is carried out on a dubbed audio corresponding to the second text by an artificial intelligence model;
segmenting the first text to obtain a plurality of first text segments, and segmenting the second text to obtain a plurality of initial second text segments, the content length of the first text segment being greater than that of the initial second text segment;
for each first text segment in the first text, sequentially determining a target second text segment that is subjected to an enhancement processing and matched with the first text segment, the enhancement processing referring to movement processing carried out on an endpoint position of an initial second text segment as a processing target in the second text; and
based on a plurality of target second text segments respectively matched with the plurality of first text segments in the first text, determining a text matching result of the first text and the second text, the text matching result being used for positioning to the corresponding first text segment, based on the second text segment corresponding to a current dubbed content, in the process of playing the dubbed audio and synchronously displaying the first text.

An embodiment of the present disclosure further provides a computer-readable storage medium storing computer programs, and the computer programs upon being run by at least one processor, execute the steps of the method for text processing described in the above method embodiment. The storage medium may be a volatile or nonvolatile computer-readable storage medium.

An embodiment of the present disclosure further provides a computer program product carrying program codes, the program codes including instructions that can be used to execute the steps of the method for text processing described in the above-mentioned method embodiment. For details, please refer to the above-mentioned method embodiment, and the details are not repeated here.

The computer program product may be specifically implemented by hardware, software or a combination thereof. In one alternative embodiment, the computer program product is embodied as a computer storage medium, and in another alternative embodiment, the computer program product is embodied as a software product, such as a software development kit (SDK) and the like.

It can be clearly understood by those skilled in the art that, for convenience and simplicity of description, specific working processes of the apparatus described above may refer to the corresponding processes in the foregoing method embodiment, which are omitted here. In the several embodiments provided in the present disclosure, it is to be understood that the disclosed apparatus and method may be implemented in other manners. The above-described apparatus embodiments are merely illustrative. For example, the division of the units may be merely a logical function division, and in actual implementation, there may be another division mode. For another example, multiple units or components may be combined or integrated into another system, or some features may be omitted, or may not be executed. In addition, the displayed or discussed mutual couplings or direct couplings or communication connections may be implemented through some communication interfaces. The indirect couplings or communication connections between the apparatuses or units may be implemented in electronic, mechanical, or other forms.

The units described as separate parts may or may not be physically separate, and the components displayed as units may or may not be physical units, that is, they may be located in one position, or may be distributed on a plurality of network units. Some or all of the units may be selected according to actual needs to achieve the purposes of the solutions of the embodiments.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a nonvolatile computer-readable storage medium executable by a processor. Based on such understanding, the technical solutions of the present disclosure, which are essential or part of the technical solutions contributing to the related art, may be embodied in the form of a software product, which software product is stored in a storage medium and includes several instructions for causing a computer device (which may be a personal computer, a server, or a network device, etc.) to execute all or part of the steps of the methods described in the embodiments of the present disclosure. The aforementioned storage medium includes a U disk, a mobile hard disk, a read-only memory (ROM), a random access memory (RAM), a magnetic disk or an optical disk and other media that can store program codes.

Finally, it should be noted that the above-mentioned embodiments are merely specific embodiments of the present disclosure, which are used to illustrate the technical solutions of the present disclosure, but not to limit the technical solutions, and the scope of protection of present disclosure is not limited thereto. Although the present disclosure is described in detail with reference to the foregoing embodiments, those of ordinary skill in the art should understand that any person familiar with the art can still make modifications or changes to the embodiments described in the foregoing embodiments, or make equivalent substitutions for some of the technical features, within the technical scope of the present disclosure; and such modifications, changes or substitutions do not make the essence of the corresponding technical solution deviate from the spirit and scope of the technical solutions of the embodiments of the present disclosure, and should be included in the scope of protection of the present disclosure. Therefore, the scope of protection of the present disclosure shall be subject to the scope of protection of the appended claims.

1. A method for text processing, comprising:
acquiring a first text and a second text which are to be compared, wherein the first text is a text obtained after text conversion processing is carried out on a dubbed audio corresponding to the second text by an artificial intelligence model;
segmenting the first text to obtain a plurality of first text segments; segmenting the second text to obtain a plurality of initial second text segments, wherein a content length of a first text segment is greater than a content length of an initial second text segment;
sequentially determining, for each first text segment in the first text, a target second text segment that is subjected to an enhancement processing and matched with the first text segment, wherein the enhancement processing refers to movement processing carried out on an endpoint position of an initial second text segment as a processing target in the second text; and
determining, based on a plurality of target second text segments respectively matched with the plurality of first text segments in the first text, a text matching result of the first text and the second text, wherein the text matching result is used for positioning to a corresponding first text segment, based on a second text segment corresponding to a current dubbed content, in a process of playing the dubbed audio and synchronously displaying the first text.

2. The method according to claim 1, wherein the sequentially determining, for each first text segment in the first text, a target second text segment that is subjected to an enhancement processing and matched with the first text segment comprises:
sequentially determining, according to a logical sequence of each first text segment in the first text, the target second text segment that is subjected to the enhancement processing and matched with the first text segment according to steps as follows:
determining an initial second text segment to be matched with the first text segment;
carrying out the enhancement processing on the initial second text segment to obtain an enhanced second text segment corresponding to the initial second text segment; and
using, in response to a similarity between the enhanced second text segment and the first text segment being greater than a first set threshold, the enhanced second text segment as the target second text segment matched with the first text segment, and repeatedly executing, in response to the similarity between the enhanced second text segment and the first text segment being smaller than or equal to the first set threshold, a step of determining the initial second text segment to be matched with the first text segment, until the target second text segment that is subjected to an enhancement processing and matched with the first text segment is determined.

3. The method according to claim 2, wherein the carrying out the enhancement processing on the initial second text segment to obtain an enhanced second text segment corresponding to the initial second text segment comprises:
carrying out a plurality of first movement processing on a first endpoint position of the initial second text segment in the second text to obtain a first enhanced text segment, wherein the first enhanced text segment is an enhanced text segment with a highest similarity with the first text segment, which is obtained after the plurality of first movement processing is carried out on the first endpoint position;
carrying out a plurality of second movement processing on a second endpoint position of the first enhanced text segment in the second text to obtain a second enhanced text segment, wherein the second enhanced text segment is an enhanced text segment with a highest similarity with the first text segment, which is obtained after the plurality of second movement processing is carried out on the second enhanced text segment; and
using, in response to the similarity between the second enhanced text segment and the first text segment being greater than or equal to a second set threshold, the second enhanced text segment as the enhanced second text segment.

4. The method according to claim 3, wherein the first endpoint position is a right endpoint position of the initial second text segment, and compared to a left endpoint position, the right endpoint position is farther away from an initial position of the second text; and
the carrying out a plurality of first movement processing on a first endpoint position of the initial second text segment in the second text to obtain a first enhanced text segment comprises:
moving, according to a preset movement length added value, the right endpoint position of the initial second text segment to be matched rightwards by N times to obtain N first candidate text segments corresponding to the initial second text segment to be matched, wherein a difference between a content length of an N^{th} first candidate text segment and a content length of an N-1^{th} first candidate text segment is equal to the preset movement length added value, and N is a positive integer greater than or equal to 2;
determining a second candidate text segment with a highest similarity with the first text segment in the N first candidate text segments;
moving, according to a target movement length, a right endpoint position of the second candidate text segment respectively leftwards and rightwards to obtain a third candidate text segment and a fourth candidate text segment; determining a target candidate text segment with a highest similarity with the first text segment among the second candidate text segment, the third candidate text segment, and the fourth candidate text segment;
determining, according to a movement length reduction coefficient and the target movement length, an updated target movement length when a right endpoint position of the target candidate text segment is respectively moved leftwards and rightwards; and
moving, in response to the target movement length being a positive integer, the right endpoint position of the target candidate text segment respectively leftwards and rightwards to obtain a new target candidate text segment according to the target movement length, repeatedly executing a step of according to the movement length reduction coefficient and the target movement length, determining the target movement length used when a right endpoint position of the target candidate text segment is respectively moved leftwards and rightwards, until the target movement length determined is a non-positive integer, and using the target candidate text segment obtained after last respective leftward and rightward movements as the first enhanced text segment.

5. The method according to claim 3, after the determining the target second text segment that is subjected to an enhancement processing and matched with the first text segment, further comprising:
determining a third text segment failed in matching in the first text;
executing, for each third text segment, a step of determining an initial second text segment to be matched;
using, in response to a similarity between the obtained enhanced second text segment and the third text segment being greater than a third set threshold, the enhanced second text segment as a target second text segment matched with the third text segment; and repeatedly executing, in response to the similarity between the enhanced second text segment and the third text segment being smaller than or equal to the third set threshold, a step of determining the initial second text segment to be matched, until the target second text segment that is subjected to the enhancement processing and matched with the third text segment is determined, wherein the third set threshold is smaller than the second set threshold.

6. The method according to claim 2, wherein the determining an initial second text segment to be matched comprises:
determining a matched text in the second text; and
using a text segment positioned behind an end of the matched text as the initial second text segment to be matched.

7. The method according to claim 2, wherein whether the similarity between the enhanced second text segment and the first text segment is greater than the first set threshold is determined by:
determining a first pinyin unit corresponding to each word in the enhanced second text segment and a second pinyin unit corresponding to each word in the first text segment; and
determining, according to a similarity between each first pinyin unit and each second pinyin unit, whether the similarity between the enhanced second text segment and the first text segment is greater than the first set threshold.

8. The method according to claim 1, after the determining a text matching result of the first text and the second text, further comprising:
playing, in response to a playing triggering operation for the second text, the dubbed audio corresponding to the second text;
determining, according to the second text segment corresponding to the current dubbed content and the text matching result, a first text segment corresponding to the second text segment; and
synchronously displaying positioning to the determined first text segment of the first text in the process of playing the dubbed audio.

9. A computer device, comprising: at least one processor and at least one storage, wherein the at least one storage stores machine-readable instructions executable by the at least one processor; the at least one processor communicates with the at least one storage upon running of the computer device, and the machine-readable instructions, upon being executed by the at least one processor implements a method for text processing, and the method comprises:
acquiring a first text and a second text which are to be compared, wherein the first text is a text obtained after text conversion processing is carried out on a dubbed audio corresponding to the second text by an artificial intelligence model;
segmenting the first text to obtain a plurality of first text segments; segmenting the second text to obtain a plurality of initial second text segments, wherein a content length of a first text segment is greater than a content length of an initial second text segment;
sequentially determining, for each first text segment in the first text, a target second text segment that is subjected to an enhancement processing and matched with the first text segment, wherein the enhancement processing refers to movement processing carried out on an endpoint position of an initial second text segment as a processing target in the second text; and
determining, based on a plurality of target second text segments respectively matched with the plurality of first text segments in the first text, a text matching result of the first text and the second text, wherein the text matching result is used for positioning to a corresponding first text segment, based on a second text segment corresponding to a current dubbed content, in a process of playing the dubbed audio and synchronously displaying the first text

10. The computer device according to claim 9, wherein the sequentially determining, for each first text segment in the first text, a target second text segment that is subjected to an enhancement processing and matched with the first text segment comprises:
sequentially determining, according to a logical sequence of each first text segment in the first text, the target second text segment that is subjected to the enhancement processing and matched with the first text segment according to steps as follows:
determining an initial second text segment to be matched with the first text segment;
carrying out the enhancement processing on the initial second text segment to obtain an enhanced second text segment corresponding to the initial second text segment; and
using, in response to a similarity between the enhanced second text segment and the first text segment being greater than a first set threshold, the enhanced second text segment as the target second text segment matched with the first text segment, and repeatedly executing, in response to the similarity between the enhanced second text segment and the first text segment being smaller than or equal to the first set threshold, a step of determining the initial second text segment to be matched with the first text segment, until the target second text segment that is subjected to the enhancement processing and matched with the first text segment is determined.

11. The computer device according to claim 10, wherein the carrying out the enhancement processing on the initial second text segment to obtain an enhanced second text segment corresponding to the initial second text segment comprises:
carrying out a plurality of first movement processing on a first endpoint position of the initial second text segment in the second text to obtain a first enhanced text segment, wherein the first enhanced text segment is an enhanced text segment with a highest similarity with the first text segment, which is obtained after the plurality of first movement processing is carried out on the first endpoint position;
carrying out a plurality of second movement processing on a second endpoint position of the first enhanced text segment in the second text to obtain a second enhanced text segment, wherein the second enhanced text segment is an enhanced text segment with a highest similarity with the first text segment, which is obtained after the plurality of second movement processing is carried out on the second enhanced text segment; and
using, in response to the similarity between the second enhanced text segment and the first text segment being greater than or equal to a second set threshold, the second enhanced text segment as the enhanced second text segment.

12. The computer device according to claim 11, wherein the first endpoint position is a right endpoint position of the initial second text segment, and compared to a left endpoint position, the right endpoint position is farther away from an initial position of the second text; and
the carrying out a plurality of first movement processing on a first endpoint position of the initial second text segment in the second text to obtain a first enhanced text segment comprises:
moving, according to a preset movement length added value, the right endpoint position of the initial second text segment to be matched rightwards by N times to obtain N first candidate text segments corresponding to the initial second text segment to be matched, wherein a difference between a content length of an N^{th} first candidate text segment and a content length of an N-1^{th} first candidate text segment is equal to the preset movement length added value, and N is a positive integer greater than or equal to 2;
determining a second candidate text segment with a highest similarity with the first text segment in the N first candidate text segments;
moving, according to a target movement length, a right endpoint position of the second candidate text segment respectively leftwards and rightwards to obtain a third candidate text segment and a fourth candidate text segment; determining a target candidate text segment with a highest similarity with the first text segment among the second candidate text segment, the third candidate text segment, and the fourth candidate text segment;
determining, according to a movement length reduction coefficient and the target movement length, an updated target movement length when a right endpoint position of the target candidate text segment is respectively moved leftwards and rightwards; and
moving, in response to the target movement length being a positive integer, the right endpoint position of the target candidate text segment respectively leftwards and rightwards to obtain a new target candidate text segment according to the target movement length, repeatedly executing a step of according to the movement length reduction coefficient and the target movement length, determining the target movement length used when a right endpoint position of the target candidate text segment is respectively moved leftwards and rightwards, until the target movement length determined is a non-positive integer, and using the target candidate text segment obtained after last respective leftward and rightward movements as the first enhanced text segment.

13. The computer device according to claim 11, after the determining the target second text segment that is subjected to an enhancement processing and matched with the first text segment, further comprising:
determining a third text segment failed in matching in the first text;
executing, for each third text segment, a step of determining an initial second text segment to be matched;
using, in response to a similarity between the obtained enhanced second text segment and the third text segment being greater than a third set threshold, the enhanced second text segment as a target second text segment matched with the third text segment; and repeatedly executing, in response to the similarity between the enhanced second text segment and the third text segment being smaller than or equal to the third set threshold, a step of determining the initial second text segment to be matched, until the target second text segment that is subjected to the enhancement processing and matched with the third text segment is determined, wherein the third set threshold is smaller than the second set threshold.

14. The computer device according to claim 10, wherein the determining an initial second text segment to be matched comprises:
determining a matched text in the second text; and
using a text segment positioned behind an end of the matched text as the initial second text segment to be matched.

15. The computer device according to claim 10, wherein whether the similarity between the enhanced second text segment and the first text segment is greater than the first set threshold is determined by:
determining a first pinyin unit corresponding to each word in the enhanced second text segment and a second pinyin unit corresponding to each word in the first text segment; and
determining, according to a similarity between each first pinyin unit and each second pinyin unit, whether the similarity between the enhanced second text segment and the first text segment is greater than the first set threshold.

16. The computer device according to claim 9, after the determining a text matching result of the first text and the second text, further comprising:
playing, in response to a playing triggering operation for the second text, the dubbed audio corresponding to the second text;
determining, according to the second text segment corresponding to the current dubbed content and the text matching result, a first text segment corresponding to the second text segment; and
synchronously displaying positioning to the determined first text segment of the first text in the process of playing the dubbed audio.

17. A non-transient computer-readable storage medium storing computer programs, wherein the computer programs, upon being run by at least one processor, implement a method for text processing, and the method comprises:
acquiring a first text and a second text which are to be compared, wherein the first text is a text obtained after text conversion processing is carried out on a dubbed audio corresponding to the second text by an artificial intelligence model;
segmenting the first text to obtain a plurality of first text segments; segmenting the second text to obtain a plurality of initial second text segments, wherein a content length of a first text segment is greater than a content length of an initial second text segment;
sequentially determining, for each first text segment in the first text, a target second text segment that is subjected to an enhancement processing and matched with the first text segment, wherein the enhancement processing refers to movement processing carried out on an endpoint position of an initial second text segment as a processing target in the second text; and
determining, based on a plurality of target second text segments respectively matched with the plurality of first text segments in the first text, a text matching result of the first text and the second text, wherein the text matching result is used for positioning to a corresponding first text segment, based on a second text segment corresponding to a current dubbed content, in a process of playing the dubbed audio and synchronously displaying the first text.

18. The storage medium according to claim 17, wherein the sequentially determining for each first text segment in the first text, a target second text segment that is subjected to an enhancement processing and matched with the first text segment comprises:
sequentially determining, according to a logical sequence of each first text segment in the first text, the target second text segment that is subjected to the enhancement processing and matched with the first text segment according to steps as follows:
determining an initial second text segment to be matched with the first text segment;
carrying out the enhancement processing on the initial second text segment to obtain an enhanced second text segment corresponding to the initial second text segment; and
using, in response to a similarity between the enhanced second text segment and the first text segment being greater than a first set threshold, the enhanced second text segment as the target second text segment matched with the first text segment, and repeatedly executing, in response to the similarity between the enhanced second text segment and the first text segment being smaller than or equal to the first set threshold, a step of determining the initial second text segment to be matched with the first text segment, until the target second text segment that is subjected to the enhancement processing and matched with the first text segment is determined.

19. The storage medium according to claim 18, wherein the carrying out the enhancement processing on the initial second text segment to obtain an enhanced second text segment corresponding to the initial second text segment comprises:
carrying out a plurality of first movement processing on a first endpoint position of the initial second text segment in the second text to obtain a first enhanced text segment, wherein the first enhanced text segment is an enhanced text segment with a highest similarity with the first text segment, which is obtained after the plurality of first movement processing is carried out on the first endpoint position;
carrying out a plurality of second movement processing on a second endpoint position of the first enhanced text segment in the second text to obtain a second enhanced text segment, wherein the second enhanced text segment is an enhanced text segment with a highest similarity with the first text segment, which is obtained after the plurality of second movement processing is carried out on the second enhanced text segment; and
using, in response to the similarity between the second enhanced text segment and the first text segment being greater than or equal to a second set threshold, the second enhanced text segment as the enhanced second text segment.

20. The storage medium according to claim 19, wherein the first endpoint position is a right endpoint position of the initial second text segment, and compared to a left endpoint position, the right endpoint position is farther away from an initial position of the second text; and
the carrying out a plurality of first movement processing on a first endpoint position of the initial second text segment in the second text to obtain a first enhanced text segment comprises:
moving, according to a preset movement length added value, the right endpoint position of the initial second text segment to be matched rightwards by N times to obtain N first candidate text segments corresponding to the initial second text segment to be matched, wherein a difference between a content length of an N^{th} first candidate text segment and a content length of an N-1^{th} first candidate text segment is equal to the preset movement length added value, and N is a positive integer greater than or equal to 2;
determining a second candidate text segment with a highest similarity with the first text segment in the N first candidate text segments;
moving, according to a target movement length, a right endpoint position of the second candidate text segment respectively leftwards and rightwards to obtain a third candidate text segment and a fourth candidate text segment; determining a target candidate text segment with a highest similarity with the first text segment among the second candidate text segment, the third candidate text segment, and the fourth candidate text segment;
determining, according to a movement length reduction coefficient and the target movement length, an updated target movement length when a right endpoint position of the target candidate text segment is respectively moved leftwards and rightwards; and
moving, in response to the target movement length being a positive integer, the right endpoint position of the target candidate text segment respectively leftwards and rightwards to obtain a new target candidate text segment according to the target movement length, repeatedly executing a step of according to the movement length reduction coefficient and the target movement length, determining the target movement length used when a right endpoint position of the target candidate text segment is respectively moved leftwards and rightwards, until the target movement length determined is a non-positive integer, and using the target candidate text segment obtained after last respective leftward and rightward movements as the first enhanced text segment.
